(19) United States
(12) Patent Application Publication
(10) Pub. No.: US 2013/0129444 A1
(43) Pub. Date: May 23, 2013

(54) LOCKNUT

(71) Applicants: David Brian May, Cary, IL (US); Raymond Thomas Wiltgen, Deerfield, IL (US)

(72) Inventors: David Brian May, Cary, IL (US); Raymond Thomas Wiltgen, Deerfield, IL (US)

(73) Assignee: Security Locknut LLC, Mundelein, IL (US)

(21) Appl. No.: 13/298,971

(22) Filed: Nov. 17, 2011

(51) Int. Cl. F16B 39/12; B21D 53/24

(52) U.S. Cl. 411/234; 411/237; 411/232; 470/19

(57) ABSTRACT

A locknut comprising a metal nut including a threaded internal wall for engaging a threaded shaft; and a metal ring including an internal threaded wall defining a hole for engaging the threaded shaft. The ring comprised of a steel alloy. The threaded internal wall of the nut and the threaded internal wall of the ring being in general axial alignment when the ring is received by a bore of the nut. The ring has an elliptical configuration and is configured to distort to a circular configuration when the threaded shaft is engaged with the threaded internal wall of the nut and the threaded internal wall of the ring. The ring sized such that the stress in the ring when the ring is distorted to the generally circular configuration is less than the yield stress of the steel alloy. A thermal diffusion coating may be applied to the ring.

The present disclosure relates to a locknut and to a method of constructing a locknut.

### BACKGROUND

Metal two piece locknuts comprising a metal nut and a metal ring disposed therein and rotatably secured thereto are well known. The metal nut and metal ring are axially aligned and have threads that align to threadingly engage a bolt. Such locknuts rely on distortion of the ring to create force on the bolt to secure together the locknut and the bolt. The rings are subject to high stresses during the fastening process and during distortion to achieve a strong holding effect. This high stress, however, impacts other properties of the locknut. For example, the high stress tends to limit the reusability of the locknuts and the re-tightening ability of the locknuts after they have been used because the rings do not return to their original size after disengagement from the bolt. Because it affects the steel properties, the high stress also tends to shorten the life of the locknuts where the locknuts are used in high vibration or harsh environments, such as, for example, in mining, crushing and pulverizing operations.

### SUMMARY

The present disclosure relates to a locknut comprising a metal nut and a metal ring. The nut includes a threaded internal wall defining a bore for threadingly engaging a threaded shaft. The ring includes an internal threaded wall defining a hole for threadingly engaging the threaded shaft. The ring is comprised of a steel alloy. The ring is receivable by the bore. The threaded internal wall of the nut and the threaded internal wall of the ring are in general axial alignment when the ring is received by the bore of the nut. The ring has a generally elliptical configuration and is configured to distort to a generally circular configuration when the threaded shaft is threadingly engaged with the threaded internal wall of the nut and the threaded internal wall of the ring. The ring is sized such that the stress in the ring when the ring is distorted to the generally circular configuration is less than the yield stress of the steel alloy. The ring may be rotatably locked to the nut. The ring may include a lug and the nut may define a slot contiguous with the bore of the nut for receiving the lug to rotatably lock the ring and nut when the ring is within the bore of the nut. A thermal diffusion coating may be applied to the ring.

The present disclosure is also directed to a method for constructing the locknut including sizing the ring such that the stress in the ring when the ring is distorted to the generally circular configuration is less than the yield stress of the steel alloy. The method may include coating the ring with the thermal diffusion coating.

Features and advantages of the disclosure will be set forth in part in the description which follows and the accompanying drawings described below, wherein one or more embodiments of the disclosure is described and shown, and in part will become apparent upon examination of the following detailed description taken in conjunction with the accompanying drawings.

### BRIEF DESCRIPTION OF THE DRAWINGS

The present disclosure and the advantages thereof will become more apparent upon consideration of the following detailed description when taken in conjunction with the accompanying drawings:

FIG. 1 is an exploded view of a locknut in accordance with an embodiment of the present disclosure and a bolt for assembly on the locknut;

FIG. 2 is a perspective view of the locknut and bolt of FIG. 1 assembled together;

FIG. 3 is a top view of the ring of the locknut of FIGS. 1 and 2 before it has been engaged with the nut; and

FIG. 4 is schematic in nature, illustrating a method for sizing the ring of a locknut in accordance with an embodiment of the present disclosure.

### DETAILED DESCRIPTION OF THE ILLUSTRATED EMBODIMENT

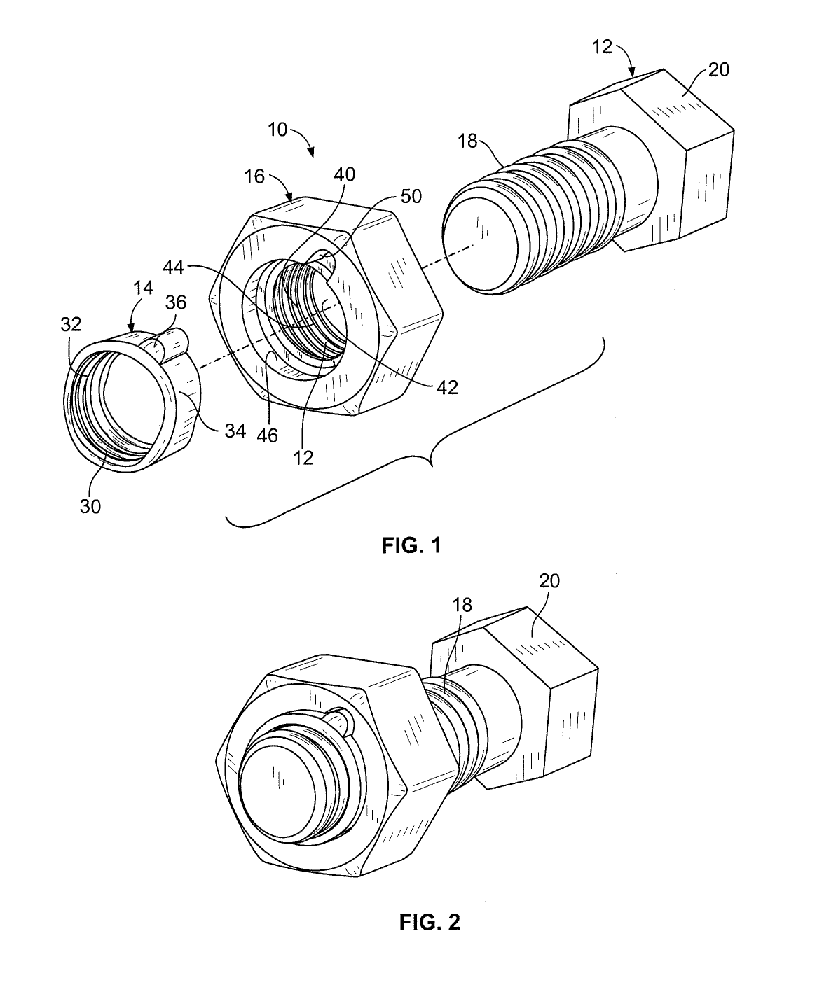

FIGS. 1-4 illustrate generally a locknut 10 in accordance with an illustrated embodiment of the present disclosure engaged with a bolt 12. The illustrated locknut 10 comprises generally a metal ring 14 and a metal nut 16. In the illustrated embodiment, the bolt 12 has a threaded shaft 18 and a bolt head 20. The threaded shaft 18 and the bolt 12 may have any suitable size and shape and may be in the form of any other suitable threaded fastener. The bolt head 20 may define a recess (not shown) for receiving an allen wrench or the like. In accordance with other embodiments of the present disclosure, the threaded shaft 18 may be by itself or may be associated with any other bolt or non-bolt structure.

The illustrated ring 14 includes a threaded inner wall 30 defining a threaded through hole 32 for threadingly engaging the threaded shaft 18 of the bolt 12, and an outer surface 34 having a lug 36 for rotatably locking the ring to the nut 16 as hereinafter described. The illustrated lug 36 has a semi-circular configuration and extends substantially the entire height of the ring 14. The illustrated lug 36 may be beveled on one or both ends. In accordance with other embodiments of the present disclosure, the lug 36 may have any other suitable structure and the ring 14 may include additional lugs. Further, in accordance with other embodiments of the present disclosure, the ring 14 may include any other suitable locking structure for rotatably locking the ring to the nut 16, such as, for example, one or more knurls, keyways, dowel pins or the like.

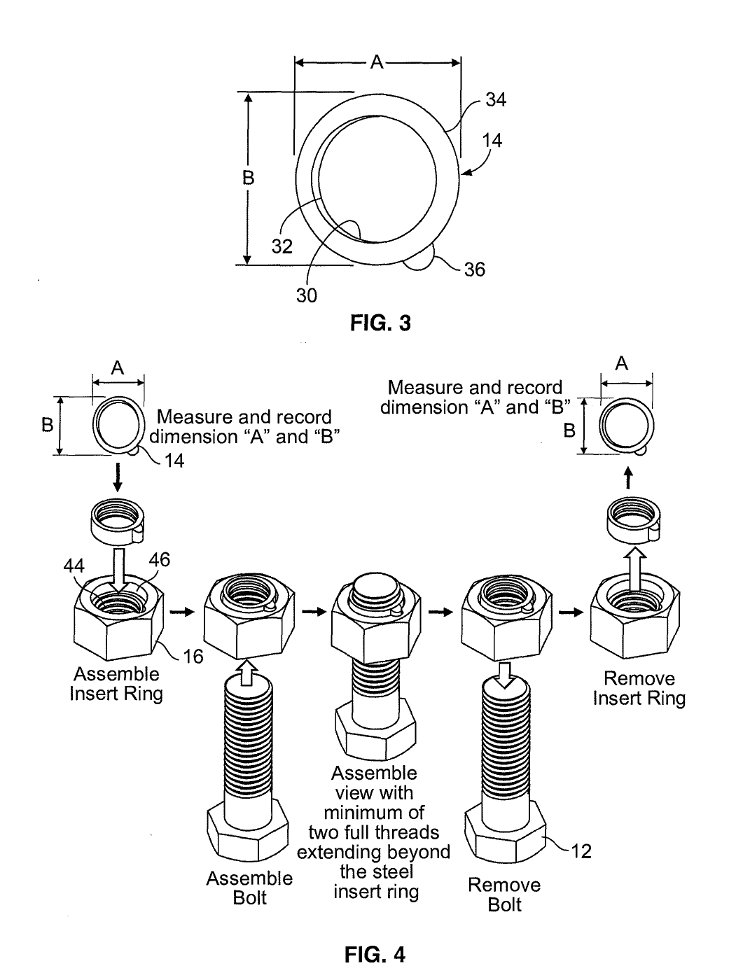

Before securing to the nut 16, the ring 14 initially has a generally elliptical shape, which herein is intended to mean a shape where, with reference to FIG. 3, a width dimension “A” of the ring is less than a length dimension “B” of the ring. The generally elliptical shape is not intended to require symmetry, especially since the ring 14 may need to be distorted to achieve its generally elliptical shape. The ring 14 may be made from any suitable steel alloy or any other suitable material. The ring 14 may have any other structure and configuration in accordance with other embodiments of the present disclosure.

A thermal diffusion coating may be applied to the ring 14 in accordance with an embodiment of the present disclosure. The thermal diffusion coating may be applied in any suitable manner. The thermal diffusion process creates a zinc metal layer alloyed to the surface of the ring 14, utilizing a zinc powder formulation or other suitable formulation. The formulation may, for example, be a product called ArmorGalv® sold by Distek N. A LLC of Elk Grove, Ill. The ring 14 may be coated by adding the ring and a suitable amount of the formulation to a drum, which is sealed and heated in an oven or the like. The drum rotates slowly in the oven, while it undergoes a multi-stage heating and cooling cycle. The thermal diffusion coating may be applied in any other suitable manner in accordance with other embodiments of the present disclosure. The thermal diffusion coating adds to the life of the locknut 10 because, among other reasons, it reduces galling between the ring 14 and threaded shaft 18.

The nut 16 has a hexagonal configuration and includes an inner wall 40 that defines a generally cylindrical bore 42. A portion of the inner wall 40 is threaded and defines a threaded bore 44 within bore 42 and a portion of the inner wall is unthreaded that defines an unthreaded bore 46 within bore 42 general axially aligned with the threaded bore 44. The threaded portion of the inner wall 40 is for threadingly engaging the threaded shaft 18 of the bolt 12. The ring 14 is received by the unthreaded bore 46. A top face of the nut 16 defines a slot 50 contiguous with the unthreaded bore 46 for receiving the lug 36 of the ring 14 to rotatably lock the ring to the nut. The nut 16 may be made of steel or any other suitable material. The nut 16 may have any other suitable structure and configuration in accordance with other embodiments of the present disclosure.

The assembled locknut 10 includes the nut 16 and ring 14, the ring being rotatably locked to the nut. The ring 14 is disposed within the unthreaded bore 46 and the lug 36 disposed within the slot 50 defined by the nut 16. The threaded internal wall 30 of the ring 14 is in general axial alignment with the threaded portion of the internal wall 40 of the nut 16. There may be separation between the threaded internal wall 30 of the ring 14 and the threaded portion of the inner wall 40 even though they are in general axial alignment. The ring 14 with its generally elliptical configuration is disposed within the substantially cylindrical unthreaded bore 46. The ring 14 may be squeezed or pressed in any suitable manner as it is inserted into the unthreaded bore 46. The generally elliptical shape of the ring 14 engages the unthreaded portion of the inner wall 40 of the nut 16 to maintain the ring within the unthreaded bore 46.

To secure the locknut 10 to the bolt 12, the threaded shaft 18 of the bolt is inserted into the bore 42 opposite the ring 14 and is threadingly engaged with the threaded internal wall 40 of the nut 16. As the bolt 12 is rotated relative to the locknut 10, or vice versa, the threaded shaft 18 threadingly climbs the threaded internal wall 40 of the nut and the threaded internal wall 30 of the ring 14. As the rotation continues, the threaded shaft 18 of the bolt 12 causes the ring 14 to distort to a generally circular shape, which herein is intended to mean a somewhat circular shape but is not intended to require symmetry. The distortion increases the stress in the ring 14. Rotational resistance results from the ring 14 due to its distorted condition such that a strong lock is provided between the ring and the threaded shaft 18 of the bolt 12 to secure the bolt to the locknut 10 and to prevent unlocking.

The distortion of the ring 14 creates a force normal to the direction of the axis of the threaded shaft 18. This force causes friction between the ring 14 and the threaded shaft 18 of the bolt 12 as the bolt is rotated, and the increased force results in improved functionality of the locknut 10. As the force is increased, there is an increased likelihood of galling between the mating surfaces, but that likelihood is reduced due to the thermal diffusion coating that may be applied on the ring 14.

In accordance with the present disclosure, due to the dimensions of the ring 14, the stress in the ring as it is distorted during the engagement of the locknut 10 and the shaft 18 of the bolt 12 is less than the yield stress of the steel alloy of the ring 14. Because the stress in the distorted ring 14 is below the yield stress, the ring will normally return to its original size and shape once the shaft 18 is disengaged from the locknut 10. The locknut 10 in accordance with the present disclosure therefore can be regularly re-tightened and can be re-used. Additionally, because the stress is below the yield stress, the ring 14 is less susceptible to cracking failure, less likely to decrease in performance over time, and less likely to decrease in performance with repeated use. The inclusion of the thermal diffusion coating also provides benefits.

Designing or otherwise constructing the ring 14 and nut 16 such that the stress in the ring 14 during engagement is less than the yield stress of the steel alloy of the ring 14 can be achieved by engineering principles and/or by trial and error. The design depends in large part on correctly sizing the diameter and thickness of the ring 14 before it has been distorted to a generally elliptical shape. With reference to FIG. 4, the ring can be sized as follows: Measure dimension A and dimension B of the ring 14 before installation into the nut 16. Assemble the ring 14 into the nut 16. Install the locknut 10 on the threaded shaft 18 of the bolt 12. Remove the locknut 10 from the bolt 12. Disassemble the ring 14 from the nut 16. Again measure dimensions A and B of the ring 14. If either of the dimensions has varied by, for example, more than 0.002″ (which accounts in large part for measuring error), the ring 14 needs to be re-sized by, for example, changing its initial diameter and/or thickness before distortion to the generally elliptical shape. This can be repeated on a trial and error basis until the ring is correctly sized. The ring 14 and nut 16 can be sized and verified in any other suitable manner in accordance with other embodiments of the present disclosure.

Prior art efforts to manufacture an effective two piece all metal locknut with a metal locknut and metal ring have always been based on distorting the ring 14 such that the stress in the ring during engagement with the bolt 12 exceeds the yield stress of the ring material because it provides strong holding power for the locknut 10. Distorting the ring 14 such that the stress in the ring exceeds the yield stress of the ring material, however, affects the reusability of the locknut 10 and also affects the ability to re-tighten the locknut over time because the ring is unable to return substantially to its original condition. Further, distorting the ring 14 such that the stress in the ring exceeds the yield stress of the ring material also affects the life of the locknut in high vibration and harsh environments, such as, for example, in mining, crushing and pulverizing operations. With the locknut 10 of the present disclosure, the stress in the ring 14 during distortion to the generally circular shape is less than the yield stress of the ring material and as a result, lasts longer, is more likely to be re-useable and re-tightenable and is better to able to withstand high vibration and harsh environments for extended durations. The thermal diffusion coating on the ring reduces or eliminates galling and further enhances the ability of the ring to withstand high vibration and harsh environments.

While embodiments have been illustrated and described in the drawings and foregoing description, such illustrations and descriptions are considered exemplary and not restrictive in character, it being understood that only illustrative embodiments have been shown and described and that all changes and modifications that come within the spirit of the invention are desired to be protected. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure.

The claimed invention is:

1. A locknut comprising:
a metal nut including a threaded internal wall defining a bore for threadingly engaging a threaded shaft; and
a metal ring including an internal threaded wall defining a hole for threadingly engaging the threaded shaft, the ring comprised of a steel alloy, the ring receivable by the bore and the threaded internal wall of the nut and the threaded internal wall of the ring being in general axial alignment when the ring is received by the bore of the nut, the ring having a generally elliptical configuration and being configured to distort to a generally circular configuration when the threaded shaft is threadingly engaged with the threaded internal wall of the nut and the threaded internal wall of the ring, the ring being sized such that the stress in the ring when the ring is distorted to the generally circular configuration is less than the yield stress of the steel alloy.

2. The locknut of claim 1 further comprising a thermal diffusion coating applied to the ring.

3. The locknut of claim 2 wherein the thermal diffusion coating includes a zinc formulation.

4. The locknut of claim 1 wherein the ring is rotatably locked to the nut.

5. The locknut of claim 1 wherein the ring includes a lug and the nut defines a slot contiguous with the bore of the nut for receiving the lug to rotatably lock the ring and nut when the ring is within the bore of the nut.

6. The locknut of claim 1 wherein the nut includes an unthreaded internal wall in general axial alignment with the threaded internal wall of the nut and wherein the bore comprises a threaded bore defined by the threaded internal wall of the nut and an unthreaded bore defined by the unthreaded internal wall of the nut, the unthreaded bore receiving the ring and the unthreaded internal wall engaging the ring when the ring is received by the bore of the nut.

7. A locknut comprising:
a metal nut including a threaded internal wall defining a bore for threadingly engaging a threaded shaft, the nut defining a slot contiguous with the bore; and
a metal ring including a threaded internal wall defining a hole for threadingly engaging the threaded shaft, the ring comprised of a steel alloy, the ring receivable by the bore and the threaded internal wall of the nut and the threaded internal wall of the ring being in general axial alignment when the ring is received by the bore, the ring including a lug receivable by the slot to prevent rotation of the ring relative to the nut, the ring having a generally elliptical configuration and being configured to distort to a generally circular configuration when the threaded shaft is threadingly engaged with the threaded internal wall of the nut and the threaded internal wall of the ring, the ring being sized such that the stress in the ring when the ring is distorted to the generally circular configuration is less than the yield stress of the steel alloy.

8. The locknut of claim 7 further comprising a thermal diffusion coating applied to the ring.

9. The locknut of claim 8 wherein the thermal diffusion coating comprises a zinc formulation.

10. The locknut of claim 7 wherein the nut includes an unthreaded internal wall defining the bore of the nut, the unthreaded internal wall in general axial alignment with the threaded internal wall of the nut and defining an unthreaded portion of the bore for receiving the ring when the ring is received by the bore of the nut.

11. A method for constructing a locknut, the locknut comprising a metal nut including a threaded internal wall defining a bore for threadingly engaging a threaded shaft and a metal ring including a threaded internal wall defining a hole for threadingly engaging the threaded shaft, the ring comprised of a steel alloy, the ring receivable by the bore and the threaded internal wall of the nut and the threaded internal wall of the ring being in general axial alignment when the ring is received by the bore of the nut, the ring having a generally elliptical configuration and being configured to distort to a generally circular configuration when the threaded shaft is threadingly engaged with the threaded internal wall of the nut and the threaded wall of the ring, the method comprising: sizing the ring such that the stress in the ring when the ring is distorted to the generally circular configuration is less than the yield stress of the steel alloy.

12. The method of claim 11 applying a thermal diffusion coating to the ring before sizing the ring.

13. The method of claim 12 wherein the coating comprises a zinc formulation.

14. The method of claim 11 wherein sizing the ring includes:
(a) threadingly engaging the threaded shaft with the threaded internal wall of the nut and the threaded internal wall of the ring to distort the ring to the generally circular configuration; and
(b) disengaging the threaded shaft from the threaded internal wall of the nut and the threaded internal wall of the ring; and
(c) determining whether the ring has returned substantially to its generally elliptical shape after disengaging the threaded shaft from the threaded internal wall of the nut and the threaded internal wall of the ring.

15. The method of claim 14 wherein sizing the ring further includes measuring a length and a width of the ring before (a), and wherein (c) includes measuring the length and the width of the ring after disengaging the threaded shaft from the threaded internal wall of the nut and the threaded internal wall of the ring and determining whether the length and the width of the ring before (a) is substantially the same as the length and the width of the ring after disengaging the threaded shaft from the threaded internal wall of the nut and the threaded internal wall of the ring.

16. The method of claim 14 wherein the nut includes an unthreaded internal wall in general axial alignment with the threaded internal wall of the nut and wherein the bore comprises a threaded bore defined by the threaded internal wall of the nut and an unthreaded bore defined by the unthreaded internal wall of the nut, and during (a) the ring is received by the unthreaded bore and the unthreaded internal wall and the ring are engaged.
